(19) United States
(12) Patent Application Publication
(10) Pub. No.: US 2011/0247392 A1
(43) Pub. Date: Oct. 13, 2011

(54) FAST ABRASION TEST FOR GRANULES

(75) Inventors: Marisa Cruz, Grokrotzenburg (DE); Rainer Fuchs, Moembris (DE); Frank Dieter Kuhn, Gelnhausen (DE)

(73) Assignee: Evonik Degussa GmbH, Essen (DE)

(21) Appl. No.: 13/140,911

(22) PCT Filed: Dec. 29, 2009
(86) PCT No.: PCT/EP2009/067974

§ 371 Date: Jun. 20, 2011

(30) Foreign Application Priority Data
Jan. 13, 2009 (DE) 10 2009 000 175.1

(51) Int. Cl. G01N 3/56

(52) U.S. Cl. 73/7

(57) ABSTRACT

Fast test for determining the abrasion of granules, in the case of which
i.) granules are milled,
ii.) the milled product is subjected to a sieve analysis, and
iii.)the results of the sieve analysis are compared with at least one reference value in order to classify the abrasion of the granules,
   the granules being milled in a cutting mill.

### FIELD OF THE INVENTION

The present invention relates to a fast abrasion test for granules, preferably inorganic or organic granules, with particular preference plastic granules, in particular for artificial lawn filling materials. In addition, the fast test of the present invention enables the determination of the strength and the adhesion of material layers on surfaces or in interlayers of multilayer granules.

### PRIOR ART

Plastic granules are a typical supply form of thermoplastics from the base material manufacturers for the plastic processing industry. Because of their free-flowing capability, they are a bulk material, such as sand or gravel, and therefore can be transported and further processed comparatively easily.

There has recently been intensive discussion of the use of plastic granules as filling material for artificial lawns. For example, European Patent Application EP 1 416 009 A1 discloses the use of coated rubber particles as bedding material or as a loose elastic layer for artificial lawns or other floor coverings. The rubber particles are of irregular n-polygon shape and preferably have a mean size of between 0.4 mm and 2.5 mm up to a maximum of 4.0 mm. The individual rubber particles are provided over their complete surface with a 5 μm to 35 μm thick coat. The coat forms a permanently elastic coating which is intended largely to prevent pollutants, such as zinc, from being washed out. In addition, the aim is for this encapsulation to reduce a rubber smell typical of old rubber.

Such plastic granules must, inter alia, have a high abrasion resistance to be applied as filling material for artificial lawns. However, there is no test known to date by means of which the abrasion resistance of plastic granules can be determined and estimated quickly and cost-effectively in a simple way.

To date, the so-called Hardgroove test in accordance with ISO-5074 has been carried out for testing the abrasion resistance of artificial lawn granules (infill materials). To this end, the plastic granules are milled in a special ball mill (500 revolutions), no pulverizing or other changes to the rubber granules being permitted. The particle size of the plastic granules is determined before and after milling and an intercomparison is made, an abrasion resistance of at least 95% being required in order to withstand the test.

This test has many disadvantages, however:
It produces relatively little abrasion (required abrasion stability 95% when the test is carried out exactly with suitable filling materials). It is true that it is advantageous in permitting as many artificial lawn particle systems as possible, but not in allowing the suitability of various materials to be determined in a fast and simple way and to be intercompared meaningfully. For example, this method means different coatings which have a different abrasion behaviour cannot be distinguished from one another, or can be only weakly, because the measurement results which occur lie very close next to one another. It is thereby impossible to undertake, for example, any “ranking”, that is to say any classification of variously abrasion resistant coatings relative to one another. Or, such a classification succeeds only in a narrow frame which differs only slightly, or not at all, from the customary width of fluctuation of the measurement values obtained. When filling materials are being classified with this test by ISA, all products with an abrasion stability of ≧95% are classified as suitable for use as artificial lawn filling materials in accordance with the Netherlands Standard for rubber-based infill materials, ISA-M37.
In addition, the required ball mill is comparatively expensive.
The test is extremely time-consuming, since 500 revolutions are required, and very complicated, for example, because of the weight of the equipment, the test apparatus can scarcely be transported, emptying of the apparatus as quantitatively as possible is extremely time-consuming and difficult, because many particles remain adhering to the large surface, for example owing to electrostatic charging effects of the particles or the test apparatus surface.
The method requires a very great deal of sample material.
It is difficult to control the temperature of the mill in order to be able to measure the abrasion behaviour at various temperatures.

From time to time, use has also been made of other abrasion test methods for filling granules, for example by means of a roller block or annular shear cell. These methods also exhibit substantial disadvantages. The production of detectable and/or measurable abrasion by means of a roller block requires a very long time. Moreover, a quantitative transfer of the fines produced is from very difficult to impossible because of the high surface and possible high electrostatic charging. It is a complicated matter to fill and to empty the equipment, and difficult to control its temperature in order to be able to measure the abrasion behaviour at various temperatures.

A long time is likewise required to produce detectable and/or measurable abrasion by means of an annular shear cell. It is difficult after the milling to transfer the material quantitatively from the apparatus, and it is likewise difficult to clean the apparatus. The temperature of the apparatus can also be controlled only with difficulty so as to be able to measure the abrasion behaviour at various temperatures.

The abrasion determining methods (DIN 53516) for plastic blocks and fleeces (and thus, for example, for through-coloured material, such as EPDM or TPE) are described in DIN V18035-7:2002-06 and cannot be applied for abrasion measurements on coated rubber granules from old tyres.

The same holds for the abrasion test, described in DIN ISO 4649, for cylindrical elastomeric samples which are exposed to a defined abrasion loading by means of an emery paper. This test, too, cannot be applied for granules composed of small pieces.

### ABSTRACT OF THE INVENTION

It was therefore an object of the present invention to indicate possibilities for fast testing of the abrasion resistance of granules, in particular of filling materials for artificial lawns.

There was, in addition, a desire for a fast test for determining the strength and the adhesion of material layers on surfaces or in interlayers of multilayer granules.

It should be possible for the test to be carried out as quickly as possible and as effectively as possible and to be used as universally as possible, and to permit the abrasion of various granules to be classified as accurately as possible. It should in this case be suitable for testing on coated rubber particles, in particular.

Furthermore, the fast test should fulfil the following conditions where possible:
Determining the abrasion and, if appropriate, further properties as economically as possible.
Determining the abrasion and, if appropriate, further properties as quickly as possible.
Simplest possible handling.
Capacity to be used as universally as possible; any test apparatus which may be required should be capable of being transported as easily as possible and require as little space as possible.
As small a specimen amount as possible.
Very sensitive test which permits the abrasion behaviour of very similar materials to be estimated and classified as accurately as possible, and, in particular,
   still the abrasion behaviours even of very similar but not identical coatings can be distinguished.
   Permits the distinguishing of likewise coated rubber particles or uncoated rubber particles, but different weathering or pre-treatment of the product.
   Permits distinguishing of likewise coated organic or inorganic articles or polymers or distinguishing of uncoated organic or inorganic articles or polymers after different weathering or pre-treatment.
As far as possible, not only the measurement of a point, that is to say the abrasion at a specific instant, but the measurement of a profile of the abrasion over time, in order to be able to determine the abrasion behaviour of granules, in particular of coatings, coating/rubber interfaces, rubber surfaces and/or deeper rubber layers.
As far as possible, both the measurement of a defined point (for fast comparison purposes), and the measurement of various points on a curve (abrasion over time), in particular in order to obtain findings relating to the coating, the binding of the coating to the rubber surface and the rubber bulk material, relating to the pigment bonding in the coating, and/or relating to the coating thickness or the layer thickness distribution of the coating.
Capacity for use at as many different temperatures as possible, in particular at relatively high temperatures, in order to simulate the behaviour of artificial lawn filling materials in the uppermost filling material layer in summer, and/or at low temperatures, in order to simulate the behaviour of artificial lawn filling materials in the cold season (autumn, winter).
As far as possible, indications of the completeness of the curing of the polymer coating in the case of coated granules.

These and further objects which result from the contexts discussed are achieved by providing a fast test having all the features of Patent Claim 1. Particularly expedient variants of the fast test are described in the subclaims, which are referred back.

By virtue of the fact that a test is carried out in which
i.) granules are milled,
ii.) the milled product is subjected to a sieve analysis, and
iii.) the results of the sieve analysis are compared with at least one reference value in order to classify the abrasion of the granules,
   the granules being milled in a cutting mill, success is achieved comparatively easily and quickly in determining the abrasion strength of granules, in particular of filling materials for artificial lawns, which are not immediately predictable. Furthermore, the test permits conclusions relating to the strength and the adhesion of material layers on surfaces or in interlayers of multilayer granules. The inventive test is in this case extremely fast, reliable and effective, can be used universally and enables a very accurate classification of the abrasion of various granules. It is particularly suitable for testing coated rubber particles which are used as filling materials for artificial lawns.

Moreover, the use of the test results in numerous further advantages:
Extremely economical determination.
Very fast test.
Very easy handling.
Capacity for universal use, carrying out possible by means of easily transportable equipment which requires little space and therefore permits, inter alia, direct measurements on site.
Small required specimen amount; in a preferred embodiment of the present invention, at most a 20 g specimen amount is required per test, whereas an approximately 100 g specimen amount is examined in the case of the Hardgroove test at the Institute ISA-Sport.
Very sensitive test which permits an exceptionally accurate estimation and classification of the abrasion behaviour of very similar materials and, in particular,
   Still allows the abrasion behaviours even of very similar but not identical coatings to be distinguished.
   Permits the distinguishing of likewise coated rubber particles or uncoated rubber particles, but different weathering or pre-treatment of the product.
   Permits distinguishing of likewise coated organic or inorganic articles or polymers or distinguishing of uncoated organic or inorganic articles or polymers after different weathering or pre-treatment.
Not only measurement of a point, but also measurement of a profile of the abrasion over time is possible, in order to be able to determine the abrasion behaviour of granules, in particular of coatings, coating/rubber interfaces, rubber surfaces and/or deeper rubber layers.
Both the measurement of a defined point (for the purposes of fast comparison), and the measurement of the various points on a curve (abrasion over time) is possible in order to obtain findings relating to the coating, the bonding of the coating to the rubber surface and the rubber bulk material, relating to the pigment bonding in the coating and/or relating to the coating thickness or the layer thickness distribution of the coating.
It is possible to determine abrasion at various temperatures, in particular at relatively high temperatures, in order to simulate the behaviour of artificial lawn filling materials in the uppermost filling material layer in summer, and/or at low temperatures, in order to simulate the behaviour of artificial lawn filling materials in the cold season (autumn, winter).
Inferences can be drawn on the completeness of the curing of polymer layers or layer systems by observing colorations or deposits on the mill wall caused by the abrasion test. This is of particular significance for the development of novel material or paint or coating systems, adhesive systems or composite systems, or of bulk material or pellets made from one or more materials.

### DETAILED DESCRIPTION OF THE INVENTION

The inventive test serves for quickly determining the abrasion resistance of granules, expediently of inorganic or organic granules, preferably of plastic granules, with particular preference of coated plastic granules, in particular of coated rubber particles which are used, inter alia, as bedding material or as a loose elastic layer for artificial lawns or other floor coverings.

Generally, the rubber particles are of irregular n-polygon shape and preferably have a mean size of between 0.4 mm and 4.0 mm. The maximum particle size of the particles is preferably less than 10 mm, with a particular preference less than 7 mm. The minimum particle size of the particles is preferably greater than 0.1 mm, with particular preference greater than 0.5 mm. The individual rubber particles are preferably provided with a 5 μm to 35 μm thick coat. The coat preferably forms a permanently elastic coating which is intended largely to prevent the washing out of pollutants such as, for example, zinc. Moreover, this encapsulation is intended to reduce a rubber smell typical of old rubber. Further details relating to such plastic granules can be gathered, for example, from European Patent Application EP 1 416 009 A1.

The inventive test is particularly capable of differentiating effectively between different coatings. Thus, the quality of coloured coatings can be assessed by a more or less strong coloration of the wall of the cutting mill after the abrasion test has been carried out. The degree of colouring of the mill wall can be determined, for example, by a visual comparison with various comparative colourings. Alternatively, it is also possible to apply other suitable methods for determining attachments on the mill wall after the carrying out of the abrasion test, in order to establish to what extent a curing of layers has advanced, this being advantageous in the case of colourless coating systems, in particular.

The inventive test can, furthermore, also be used to assess the bonding of a composite material. To this end, it is preferred to examine particles which have been obtained from the composite material and have, preferably, been cut, punched or broken from the composite material.

The inventive test comprises the following steps:

A) Milling in a cutting mill

An attempt is firstly made to comminute the granules at least partially by milling. To this end, use is made within the scope of the present invention of a cutting mill which usually consists of a horizontally or vertically arranged rotor which is fitted with blades which in the context of a first particularly preferred embodiment of the present invention operate against blades anchored in the housing of the mill. A diagrammatic sketch of such a mill is illustrated in Römpp Lexikon Chemie, Publisher: J. Falbe, M. Regitz, 10^{th} Edition, Georg Thieme Verlage, Stuttgart, N.Y., 1998, Volume: 4, Headword: “Mühle”, page 2770. Accordingly, reference is made to this document and the references named for further details.

In the context of a second particularly preferred embodiment of the present invention, the housing of the mill does not comprise any anchored blades, and so the milled granules can more easily be taken out of the housing.

The operating principle of the cutting mill is preferably cutting/impact.

The intensity of the milling can be controlled via the energy output by the mill. It is preferred to make use within the scope of the present invention of cutting mills which output an energy of the cutting mill in the range from 10 W to 400 W, particularly in the range from 50 W to 300 W.

The rotational speed of the cutting mill is preferably in the range from 100/min to 30000/min, in particular in the range from 1000/min to 25000/min.

The peripheral speed of the cutting mill is preferably in the range from 10 m/s to 100 m/s, in particular in the range from 20 m/s to 80 m/s.

The dimensioning of the mill can be freely selected in principle, and be adapted to the requirements of the individual case. The milling chamber of the cutting mill is expediently filled during milling to at least 10%, referred to the maximum useful volume of the cutting mill.

The cutting mill and the cutting tool are preferably fabricated from a harder material than the granules to be examined. The use of milling chambers and cutting blades made from stainless steel, in particular from stainless steel 1.4034, has proved itself, in particular.

Within the scope of the present invention, the milling material is preferably placed in the chamber of the cutting mill and subjected to a shear load by a stainless steel beater within a prescribed loading time (“milling period”). This give rise to mutual friction, striking and comminution of granules or of layers on the granules. Fast testing of the abrasive stability of granules, in particular of coated plastic granules, is achieved owing to the massive and complex nature of the shears. The results of the test are chiefly influenced by the following variables:
Elasticity of the coating.
Shear resistance of the coating.
Strength of the adhesion of the coating on the particles.
Size of the particles.
Size distribution of the particles.
Elasticity of the particles.
Shear resistance of the particles.

Again, the results are influenced by the duration of the milling. For the purposes of the present invention, it is preferred to select milling periods in the range from 5 seconds to 10 minutes, in particular in the range from 5 seconds to 150 seconds.

The action of the milling force of the cutting mill can occur continuously or discontinuously. A mode of procedure has particularly proved itself in which the milling force is preferably not varied during the milling.

If required, the temperatures of the milling chamber of the cutting mill can be controlled, in particular the chamber can be heated or cooled, during milling in order to obtain findings relating to the abrasion behaviour of the granules at other temperatures.

It is also conceivable to control the temperature in a changing fashion during the course of milling. To this end, it is preferred to introduce a suitable, thermally controlled liquid such as, for example, water, into the heating/cooling chamber of the milling chamber.

Cutting mills suitable for the purposes of the present invention are commercially available. The following mills have very particularly proved themselves:
Analytical mill: Universal mill M20
   Manufacturer: IKA-Werke GmbH & Co. KG
   Operating principle: cutting/impact
   Rotational speed max. (1/min.): 20000
   Material beater/blades: stainless steel 1.4034
   Material milling chambers: stainless steel 1.4031
B) Sieving of the granules subjected to a shear load

After the milling, the particle size distribution of the milled product is determined by sieve analysis, the procedure preferably being along the lines of DIN 53 477 (November 1992).

It is preferred to use round analytical sieves (called sieves, for short) whose sieve frames preferably consist of metal. The sieves preferably have a nominal diameter of 200 mm. The sieve cover, all sieve frames and the sieve pan preferably fit onto or into one another in a tight-sealing manner. The sieves are preferably stretched with metal wire mesh in accordance with DIN ISO 3310 Part 1. in many cases, a sieve assembly of 6 sieves with metal wire mesh (mesh plies: 63 μm, 125 μm, 250 μm, 500 μm, 1 mm, 2 mm) is sufficient. For the purposes of the present invention, particular preference is given to a sieve assembly which comprises a 500 μm sieve and a base.

Because of the risk of corrupting the results and damaging the sieve with metal wire mesh, it is recommended not to use mechanical sieving aids such as rubber cubes.

It is preferable to ensure through the selection of the flat sieve machine that separation into grain fractions which correspond to the sieving material is terminated after 15 minutes. The separation is preferably achieved by a horizontal, circular movement of the sieve assembly at a rotational frequency of preferably 300±30 min⁻¹ and with an amplitude of 15 mm.

It is preferred to sieve discontinuously, with particular preference in a plurality of intervals, with very special preference in 3 to 10 intervals, in particular in 5 intervals. In this case, the intervals are preferably of the same length and are expediently the length of 1 minute to 5 minutes, in particular 3 minutes. After each interval, the sieving is preferably interrupted and then restarted anew. This can be programmed on the sieve machine, if appropriate.

Suitable sieve machines are commercially available for the purposes of the present invention. The following sieve machine has proved itself very particularly:
Sieve machine: Model: AS 400 Control
   Manufacturer: Retsch GmbH
   Movement of sieving material: horizontally circular
   Rotational speed digital: 50-300 min⁻¹
   Interval operation: 1-10 min
   W×H×D: 540×260×507 mm
C) Weighing of the different sieving fractions

The determination of the particle size distribution is performed in a way known per se by weighing the sieves.

The result of the sieve analysis is compared with at least one reference value in order to classify the abrasion of the granules examined.

In this case, the determined grain size distribution of the milled product is preferably compared with the result of at least one other set of granules in order to classify the abrasion of the examined granules by comparison with the other set of granules.

Within the context of a further preferred embodiment of the present invention, the determined grain size distribution of the milled product is compared with the grain size distribution of the unmilled starting material in order to classify the abrasion of the examined granules.

Within the context of a third preferred embodiment of the present invention, the determined grain size distribution of the milled product is compared with at least one prescribed limiting value in order to classify the abrasion of the examined granules.

Moreover, the portion of particles smaller than 500 μm, in particular, has proved to be particularly suitable for the purposes of the present invention in order to assess the abrasion of the particles.

D) Optional: Testing of deposits on the walls of the milling chamber

In the context of a particularly preferred variant of the present invention, the walls are tested after the milling with regard to possible deposits that have been caused by the shear loading of the granules in the cutting mill. By optical comparison (for example with the aid of suitable reference samples, references, reference scales), it is generally possible to estimate or classify the strength and the adhesion of material layers on surfaces or in interlayers of multilayer granules.

The invention is explained further below with the aid of a plurality of examples without thereby aiming to restrict the idea of the invention.

### EXAMPLES

A plurality of samples were examined in the same way.

### Test Procedure

20 g of milling material are filled into the chamber of the cutting mill. A mill from the manufacturer IKA-Werke GmbH & Co. KG, model Universalmühle M20, is used as analytical mill. The chamber is sealed by the appropriate devices on the cover, and the milling material is milled for 110 seconds at room temperature by means of a 15° C. cooling water temperature and a 500-1000 ml/minute volume flow for the cooling of the milling pot. The milled specimen is transferred onto the previously weighed sieve by means of a hairbrush.

After the milled specimen has been transferred to the weighed sieve of a suitable sieving stack by means of a hairbrush, the wall of the analytical mill is examined visually for paint residues or deposits. The paint residues or deposits are compared with suitable references.

The sieving stack (for example 500 μm and base), to which the specimen is applied, is placed on a Retsch sieve machine, Model AS 400 Control, and the sieves are carefully clamped in by means of the sieve clamping unit. The sieve system is thereby closed. The specimen is subjected to a sieve analysis (along the lines of DIN 53477 with 5 intervals every 3 minutes).

The individual sieve residues are determined by means of a balance.

The results are evaluated as follows:

Sieve residue (%) =[sieve residue (g)−sieve tare (g)]*100/specimen initial weight (g)

Abrasion produced (%) =the difference in the particles <500 μm between milled and unmilled specimens

TABLE
Results

| | | Hardgroove | Inventive |
|---|---|---|---|
| | | abrasion | abrasion |
| Specimen | Company | test | test |
| TPE, Terra | DSM | 97 | 24.77 ± 0.11 |
| XPS | Thermoplastic | | |
| | Elastomers BV | | |
| CGTR | Evonik Degussa | 98 | 1.08 ± 0.04 |
| | GmbH | | |
| CGTR, | Granuband BV | | 3.09 ± 0.02 |
| Granufill ® | | | |
| CGTR, | Rubber | | 7.92 ± 0.08 |
| Ambigran ® | Technology | | |
| RAL 6025 | Weidmann GmbH | | |
| | & Co. | | |
| TPE, Melos ® | Melos GmbH | | 4.85 ± 0.02 |
| TPS-Infill | | | |
| EPDM, | Gezolan AG | | 7.07 ± 0.02 |
| Reseda | | | |
| green RAL | | | |
| 6011 | | | |

CGTR: coated ground tyre rubber
TPE: thermoplastic elastomer
EPDM: ethylene-porpylene-dimer copolymer

1. A fast test for determining the abrasion of granules, comprising
i.) milling granules in a cutting mill comprising a milling chamber,
ii.) subjecting the milled product to a sieve analysis, and
iii.) comparing the results of the sieve analysis with at least one reference value in order to classify the abrasion of the granules.

2. The fast test according to claim 1, wherein the output energy of the cutting mill is in the range from 10 W to 400 W.

3. The fast test according to claim 1, wherein the rotation speed of the cutting mill is in the range from 100/min to 30000/min.

4. The fast test according to claim 1, wherein the peripheral speed of the cutting mill is in the range from 10 to 100 m/s.

5. The fast test according to claim 1, wherein the milling chamber of the cutting mill is filled during milling to at least 10%, referred to the maximum useful volume of the cutting mill.

6. The fast test according to claim 1, wherein the milling chamber and any cutting blades of the milling chamber are fabricated from stainless steel.

7. The fast test according to claim 1, wherein the granules are milled for a time in the range from 5 seconds to 30 minutes.

8. The fast test according to claim 1, wherein the granules have a maximum size of less than 10 mm.

9. The fast test according to claim 1, wherein the temperature of the milling chamber is controlled during the milling.

10. The fast test according to claim 1, wherein the grain size distribution of the milled product is determined by discontinuous sieving.

11. The fast test according to claim 1, wherein the abrasion of a product produced by the milling is compared with the abrasion of other granules produced by milling, in order to classify the abrasion of the examined granules by comparison with the other granules.

12. The fast test according to claim 1, wherein the proportion of particles less than 500 μm is selected as criterion in accordance with which the abrasion of the particles is assessed.

13. The fast test according to claim 1, wherein the granules are coated.

14. The fast test according to claim 1, wherein the granules are uncoated.

15. The fast test according to claim 13, wherein the test additionally determines the strength and the adhesion of material layers on the surface of the granules or in interlayers of multilayer granules.

16. The fast test according to claim 1, wherein the granules are plastic.

17. The fast test according to claim 15, wherein partially or completely coated rubber particles are examined.

18. The fast test according to claim 15, wherein coloured or colourless polymer particles are examined.

19. The fast test according to claim 15, wherein particles are examined which have been obtained from a composite material.
